(19) United States
(12) Patent Application Publication
(10) Pub. No.: US 2025/0319697 A1
(43) Pub. Date: Oct. 16, 2025

(54) PRINT ELEMENT SUBSTRATE AND INKJET PRINTING HEAD

(71) Applicant: CANON KABUSHIKI KAISHA, Tokyo (JP)

(72) Inventors: KAZUNARI ISHIZUKA, Shizuoka (JP); HIDENORI YAMATO, Tokyo (JP)

(21) Appl. No.: 19/170,342

(22) Filed: Apr. 4, 2025

(30) Foreign Application Priority Data
Apr. 16, 2024 (JP) 2024-066206

(51) Int. Cl. B41J 2/14; B41J 2/045; B41J 2/05

(52) U.S. Cl. CPC B41J 2/14072; B41J 2/04541; B41J 2/04573; B41J 2/0458; B41J 2/05

(57) ABSTRACT

To increase the virtual length of a nozzle array while maintaining a high operating frequency, provided is a print element substrate having an energy generation element array including a plurality of energy generation elements each configured to apply energy to liquid in a corresponding pressure chamber and a pad array including a plurality of pads for inputting, from outside, a plurality of signals for driving the plurality of energy generation elements. The extension direction of the pad array has a component in the same direction as the extension direction of the energy generation element array.

This application claims the benefit of Japanese Patent Application No. 2024-066206 filed Apr. 16, 2024, which is hereby incorporated by reference wherein in its entirety.

### BACKGROUND OF THE INVENTION

### Field of the Invention

The present disclosure relates to a print element substrate and an inkjet printing head.

### Description of the Related Art

Various methods are known as a printing method for a printer. Especially with a thermal inkjet method, which uses the ink bubbling phenomenon induced by thermal energy produced by a heater energized for roughly several microseconds, a large number of nozzles can be formed at high density. A printhead employing such a method uses a print element substrate having heaters, their protective films, driver circuits (also referred to as “drive elements”) for passing current to the heaters, logical circuits for controlling the driver circuits, and the like integrally formed on a silicon single crystal substrate or the like using a semiconductor integrated circuit process.

Referring to FIG. 1, reference numeral 101 represents a base of a print element substrate 100 in the prior art. Pads 103a to 103h and 104a to 104h for providing external electric connections are disposed on the base 101 at both end portions thereof in terms of its longitudinal direction. The pads 103a to 103h are included in a first pad array 151, and the pads 104a to 104h are included in a second pad array 152. A signal terminal for transferring image data from the outside to the print element substrate 100, a power source terminal for driving, and the like are assigned to these pads. A serial signal representing image data is inputted from the outside to a DATA terminal 103f. The serial signal is synchronous with a CLK signal (clock signal) inputted to a CLK terminal 103c. The serial signal and the CLK signal are supplied to a shift register 106a via input circuits 105a and 105b. A latch signal for causing a plurality of latch circuits included in the shift register 106a to hold parallelized serial signals is inputted to an LT terminal 104c and is supplied to the plurality of latch circuits via an input circuit 105c. The signals held by the plurality of latch circuits are supplied to AND arrays 108a and 108b for selecting a given heater. Also, the DATA signal and the CLK signal are supplied to a shift register 106b as well. The shift register 106b parallelizes some of the serial signals inputted thereto and outputs it to an adjacent decoder 107b. The decoder 107 decodes the inputted signal into a plurality of individual selection signals and supplies them to the AND arrays 108a and 108b. Each AND array includes the same number of AND circuits as the heaters, and each AND circuit performs an AND operation using the signal from the shift register 106a and the signal from the decoder 107. A driver circuit in driver arrays 109a and 109b disposed in correspondence to the AND circuit that outputs “true” as a result of the AND operation is turned on and enabled. As a result, currents flow through the corresponding heater in the heater arrays 110a and 110b, causing ink to be ejected from the nozzle. The duration for heating ink is defined by a HE signal 104f. The duration for heating ink is defined using a configuration where the output from the decoder 107b is enabled with the HE signal 104f being “true.” Note that the head is configured so that ink may be introduced from an ink supply port 111 into a pressure chamber located between a heater and its corresponding nozzle.

In a typical serial printer, a nozzle array formed by nozzles arranged in, for example, a straight line extends in the same direction as the direction in which a print medium is conveyed. Thus, the length of a nozzle array is equal to a conveyance-direction length printable on a print medium with one scan. Improvement in the print speed is one of the performance factors requested of a printer. For this purpose, for example, nozzles may be increased in number to make the nozzle array longer. Also, for the above purpose, for example, the frequency of ejecting an ink droplet from a nozzle may be increased to make a scan time shorter. Making a nozzle array longer may require the print element substrate to be elongated in the direction in which the nozzle array extends.

A print element substrate disclosed in Japanese Patent Laid-Open No. 2007-118512 avoids a decrease in operating frequency due to elongation by functionally dividing print elements into two groups in the nozzle array direction and thereby decreasing the length of wiring by half.

To make the conveyance-direction length printable on a print medium with one scan even longer, for example, a plurality of print element substrates need to be joined and disposed in the nozzle array direction to make the virtual length of the nozzle array longer. The virtual length of the nozzle array needs to be made longer in this way in order also to configure a line head which has a nozzle array extending in a direction intersecting with the print media conveyance direction and which prints without moving. In such a case, the plurality of print element substrates need to be disposed closely together in the nozzle array direction.

However, the pad array on the print element substrate shown in FIG. 1 or the print element substrate disclosed in Japanese Patent Laid-Open No. 2007-118512 extends in a direction orthogonal to the nozzle array direction. Thus, in a case of using such a print element substrate, a flexible board connected to the pad array extends in the nozzle array direction. This makes it difficult to arrange a plurality of print element substrates closely together in the nozzle array direction because the flexible boards connected to the respective pad arrays on the print element substrates adjacent to each other interfere with each other. Thus, it is desirable to make the virtual length of a nozzle array longer by arranging a plurality of print element substrates closely together in the nozzle array direction while avoiding interference between the flexible boards. Such a configuration allows the length of wiring for each print element substrate to be shorter and therefore makes it possible to maintain a high operating frequency.

### SUMMARY OF THE INVENTION

The present disclosure has been made in view of the above points and aims to make the virtual length of a nozzle array longer while maintaining a high operating frequency.

In a first aspect of the present disclosure, there is provided a print element substrate comprising: an energy generation element array including a plurality of energy generation elements each configured to apply energy to liquid in a corresponding pressure chamber; a pad array including a plurality of pads used for inputting, from outside, a plurality of signals for driving the plurality of energy generation elements; a drive element array including a plurality of drive elements each configured to drive a corresponding one of the energy generation elements; a logical circuit array including a plurality of logical circuits each configured to enable a corresponding one of the drive elements based at least on data inputted from a shift register; and the shift register configured to, based on a clock signal inputted from outside, shift a serial signal inputted from outside and used for driving the plurality of energy generation elements and then hold the serial signal, wherein an extension direction of the pad array has a component in a same direction as an extension direction of the energy generation element array, the plurality of pads include at least a pad for inputting the serial signal from outside and a pad for inputting the clock signal from outside, an extension direction of the drive element array, an extension direction of the logical circuit array, and an extension direction of the shift register have a component in a same direction as the extension direction of the energy generation element array, and the pad array is disposed at a position different from the energy generation element array, the drive element array, the logical circuit array, and the shift register in a direction intersecting with the extension direction of the energy generation element array.

In a second aspect of the present disclosure, there is provided an inkjet printing head including a plate and a print element substrate provided on the plate, the print element substrate comprising: an energy generation element array including a plurality of energy generation elements each configured to apply energy to liquid in a corresponding pressure chamber; a pad array including a plurality of pads for inputting, from outside, a plurality of signals for driving the plurality of energy generation elements; a drive element array including a plurality of drive elements each configured to drive a corresponding one of the energy generation elements; a logical circuit array including a plurality of logical circuits each configured to enable a corresponding one of the drive elements based at least on data inputted from a shift register; and the shift register configured to, based on a clock signal inputted from outside, shift a serial signal inputted from outside and used for driving the plurality of energy generation elements and then hold the serial signal, wherein an extension direction of the pad array has a component in a same direction as an extension direction of the energy generation element array, the plurality of pads include at least a pad for inputting the serial signal from outside and a pad for inputting the clock signal from outside, an extension direction of the drive element array, an extension direction of the logical circuit array, and an extension direction of the shift register have a component in a same direction as the extension direction of the energy generation element array, and the pad array is disposed at a position different from the energy generation element array, the drive element array, the logical circuit array, and the shift register in a direction intersecting with the extension direction of the energy generation element array.

Further features of the present invention will become apparent from the following description of exemplary embodiments with reference to the attached drawings.

### BRIEF DESCRIPTION OF THE DRAWINGS

FIG. 1 is a schematic plan view showing a print element substrate in the prior art;

FIG. 2 is a schematic plan view showing a print element substrate according to a first embodiment;

FIG. 3 is a diagram showing the relationship of 3A and 3B;

FIG. 3A is a schematic plan view showing a print element substrate according to a second embodiment;

FIG. 3B is a schematic plan view showing a print element substrate according to a second embodiment;

FIG. 4 is a diagram showing the relationship of 4A and 4B;

FIG. 4A is a schematic plan view showing a print element substrate according to a third embodiment;

FIG. 4B is a schematic plan view showing a print element substrate according to a third embodiment;

FIG. 5 is a schematic plan view showing an inkjet printing head according to a fourth embodiment;

FIG. 6 is a schematic plan view showing an inkjet printing head according to a fifth embodiment;

FIG. 7 is a schematic plan view showing an inkjet printing head according to a sixth embodiment;

FIG. 8 is a schematic plan view showing an inkjet printing head according to a seventh embodiment; and

FIG. 9 is a schematic plan view showing an inkjet printing head according to an eighth embodiment.

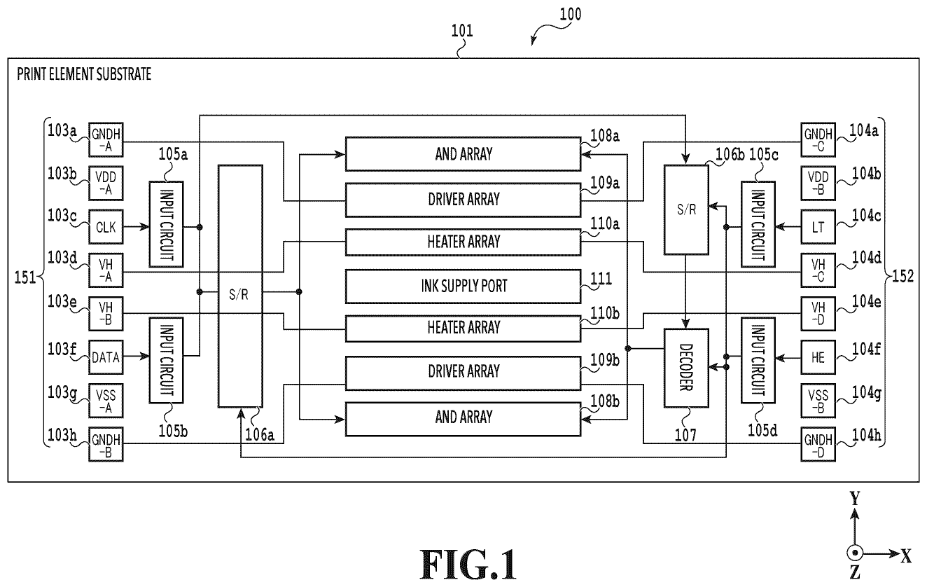

### DESCRIPTION OF THE EMBODIMENTS

Embodiments are described in detail below with reference to the drawings. Note that the embodiments below are not to limit the disclosure of the scope of claims. Although the embodiments describe a plurality of features, not all of those features are necessarily essential to the disclosure, and the plurality of features may be combined in any way. Further, throughout the drawings attached hereto, the same or like configurations may be denoted by the same reference numerals to omit repetitive descriptions.

### First Embodiment

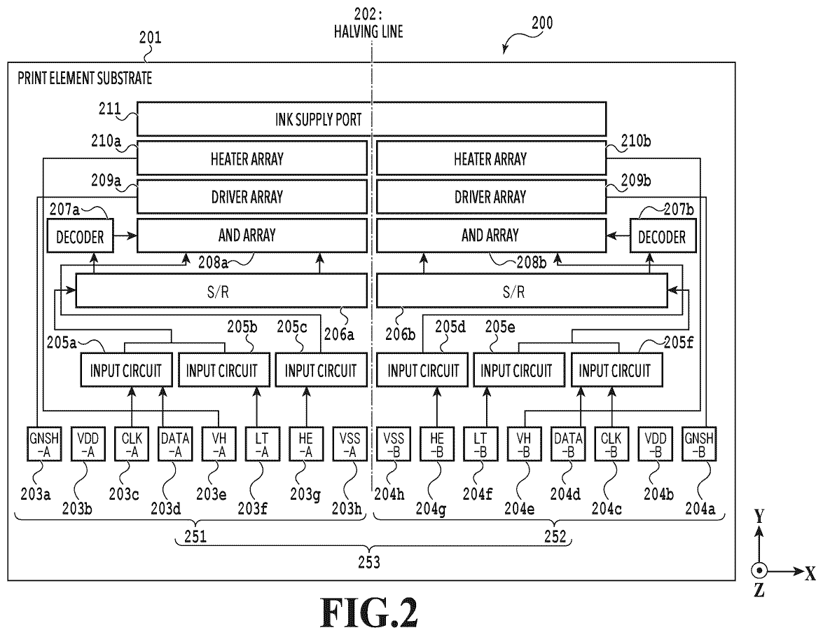

FIG. 2 is a schematic plan view showing a print element substrate according to a first embodiment.

Reference numeral 201 denotes a base of a print element substrate 200. A heater array 210a and a heater array 210b are disposed on the print element substrate 200. The heater array 210a and the heater array 210b together form a single continuous heater array. The heater array extends in an X-direction.

In correspondence to the single heater array formed by the heater array 210a and the heater array 210b together, a nozzle array (not shown) is formed in an orifice plate (not shown) attached to the print element substrate 200. Each nozzle included in the nozzle array is disposed at the same position in terms of the XY-plane as a corresponding heater included in the heater array 210a or the heater array 210b. Then, each nozzle faces its corresponding heater with a pressure chamber (not shown) interposed in between in a direction along the thickness of the print element substrate 200 (a Z-direction). Thus, in terms of the plane of the print element substrate 200 (the XY-plane), the position of the nozzle array basically coincides with an overall heater array position, i.e., the position of the heater array 210a and the position of the heater array 210b. Also, the direction in which the nozzle array extends and the direction in which the heater arrays 210a, 210b extend coincide.

Reference numeral 202 denotes a halving line for the print element substrate 200. The halving line does not actually exist on the base 201. The halving line 202 is a conceptual line extending in a direction (a Y-direction) orthogonal to the nozzle array extension direction and passing through the middle point of the heater array in terms of its extension direction (the X-direction). In a case where the number of heaters included in the heater array 210a and the number of heaters included in the heater array 210b are the same, as shown in FIG. 2, the halving line 202 passes through the border point between the heater array 210a and the heater array 210b.

Note that the halving line 202 does not necessarily needs to pass through the middle point of the heater array in terms of its extension direction (the X-direction) and may pass through a point away from the middle point. Thus, the number of heaters included in the heater array 210a and the number of heaters included in the heater array 210b do not necessarily have to be the same.

Pads 203a to 203h and pads 204a to 204h for providing external electric connections are provided on the base 201. The pads 203a to 203h are provided on the left side of the halving line 202, and the pads 204a to 204h are provided on the right side of the halving line 202. The pads 203a to 203h constitute a first pad array 251, and the pads 204a to 204h constitute a second pad array 252. For both of the pad arrays, their extension directions coincide with the directions in which the heater arrays 210a, 210b extend. Also, as described above, the direction in which the heater arrays 210a, 210b extend coincide with the nozzle array extension direction. The first pad array 251 and the second pad array 252 together constitute a single pad array 253 for the print element substrate 200.

The pad array 253 including the first pad array 251 and the second pad array 252 is disposed on a lower marginal portion of the print element substrate 200 in FIG. 2. The direction in which this marginal portion extends coincides with the direction in which the heater arrays 210a, 210b extend (the X-direction), but does not necessarily need to coincide with it precisely.

Signal terminals for transferring image data from the outside to the print element substrate 200, power supply terminals for driving, and the like are assigned to the pads 203a to 203h and the pads 204a to 204h.

The print element substrate 200 is halved by the halving line 202 into a first functional block and a second functional block. The first functional block is a functional block located on the left side of the halving line 202, and the second functional block is a functional block located on the right side of the halving line 202. In other words, the first functional block is a functional block on the left end portion side, and the second functional block is a functional block on the right end portion side.

The pads 203a to 203h correspond to the first functional block located on the left side of the halving line 202, and the pads 204a to 204h correspond to the second functional block located on the right side of the halving line 202. Signals supplied to the pads 203a to 203h from the main body of the printing apparatus are supplied to the circuits included in the first functional block on the print element substrate 200. Also, signals supplied to the pads 204a to 204h from the main body of the printing apparatus are supplied to the circuits included in the second functional block on the print element substrate 200.

The arrangement of the components belonging to the first functional block and the arrangement of the components belonging to the second functional block are symmetric with respect to the halving line 202. The components belonging to the first functional block and the components belonging to the second functional block may be formed by exposure to light separately. In this case, the halving line 202 is a joint line of the exposure to light.

An overview of the operation of each component of the first functional block is described. A serial signal representing image data is supplied to a DATA-A terminal 203d from the outside (e.g., the main body of the printing apparatus). This serial signal is in synchronization with a CLK signal supplied to a CLK-A terminal 203c.

The serial signal and the CLK signal are supplied to a shift register (S/R) 206a via an input circuit 205a including an electrostatic discharge protection circuit and the like. In this event, the serial signal is inputted from an outer end portion of the shift register 206a and is shifted toward an inner end portion thereof. The outer end portion of the shift register 206a is an end portion farther from the halving line 202, and the inner end portion of the shift register 206a is an end portion closer to the halving line 202.

Once a predetermined number of flip/flop circuits (not shown) in the shift register 206a all have a serial signal, a latch signal is supplied from the outside to an LT-A terminal 203f. The predetermined number is the same as the number of heaters included in the heater array 210a. Also, the flip/flop circuits are, for example, D-type flip/flop circuits.

By the latch signal, the serial signals at the predetermined number of flip/flop circuits in the shift register 206a are latched and held by a predetermined number of latch circuits (not shown) in the shift register 206a.

Some of the serial signals held by the latch circuits are supplied to an AND array (also referred to as a “logical circuit array”) 208a, and the rest of the serial signals held by the latch circuits are supplied to a decoder 207a. The decoder 207a expands the rest of the serial signals supplied thereto into a plurality of individual selection signals and supplies the plurality of individual selection signals to the AND array 208a.

The AND array 208a is a circuit where the same number of AND circuits (also referred to as “logical circuits”) as the heaters included in the heater array 210a are disposed in the form of an array. Each of the AND circuits performs an AND operation using the signal supplied from the latch circuit in the shift register 206a and the individual selection signal supplied from the decoder 207a. A driver circuit in a driver array (also referred to as a “drive element array”) 209a corresponding to the AND circuit that outputs “true” as a result of the AND operation is selected.

A duration for heating ink is supplied from the outside to an HE-A terminal 203g as an HE signal and is then supplied to the AND array 208a via an input circuit 205c.

The AND array 208a also includes an AND circuit for performing an AND operation using a result of the above-described AND operation and the HE signal. The selected driver circuit is turned on while the result of the AND operation performed on the result of the AND operation and the HE signal is true. Consequently, a current flows through the corresponding heater in the heater array 210a. As a result, ink in the pressure chamber (not shown) corresponding to this heater is heated to generate a bubble and is ejected from the corresponding nozzle.

The operations of the components belonging to the first functional block have been described above. Because the components belonging to the second functional block operate similarly, repetitive descriptions are omitted. While the direction in which the serial signal is shifted in the shift register 206a is from left to right in FIG. 2, it is to be noted that the direction in which the serial signal is shifted in a shift register 206b is opposite to this. A head control IC (not shown) which supplies serial signals to the print element substrate 200 is supplied with the serial signals in the same one direction. Thus, the head control IC reverses the arrangement of data in either the serial signal supplied to the DATA-A terminal 203d or the serial signal supplied to a DATA-B terminal 204d before supplying the serial signals.

Note that ink is supplied to each pressure chamber through an ink supply port 211 formed in the base 201 of the print element substrate 200. The shape, quantity, position, and the like of the ink supply port 211 do not have to be as shown in the drawings.

### Second Embodiment

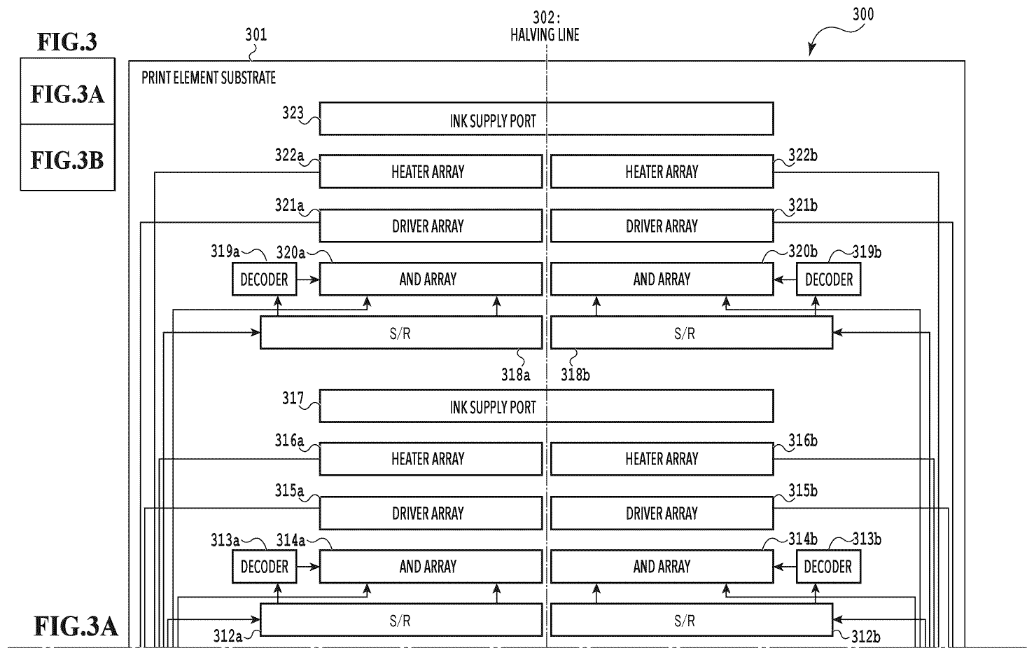

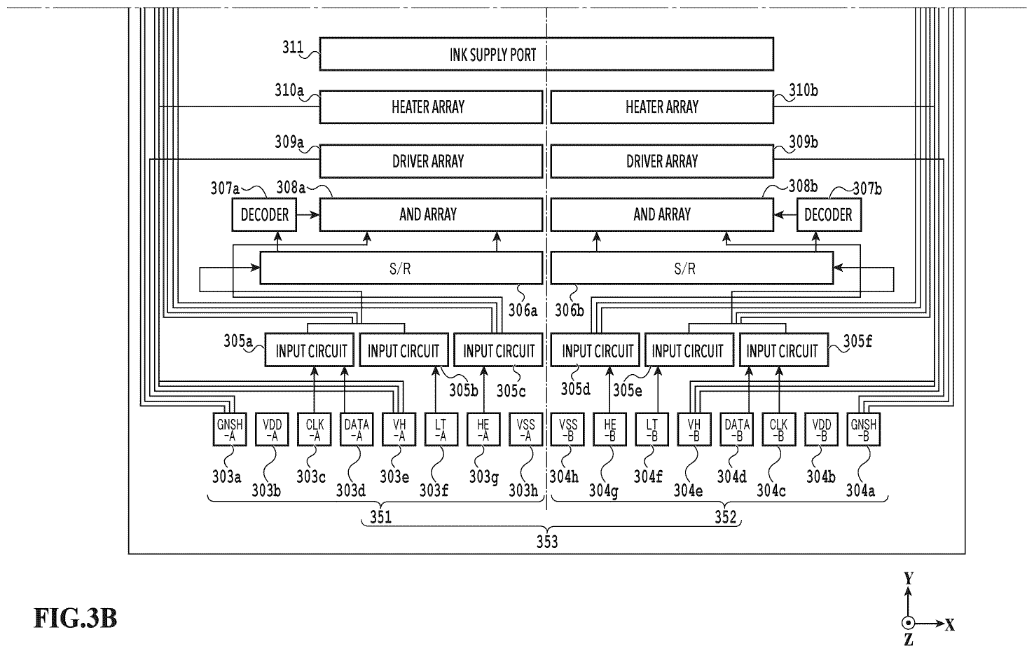

FIGS. 3A and 3B are schematic plan views showing a print element substrate according to a second embodiment.

A print element substrate 300 of the present embodiment has, on a base 301, a plurality of heater arrays arrayed in a direction (the Y-direction) intersecting with a direction in which the heater arrays extend (the X-direction). In the example shown in FIGS. 3A and 3B, three heater arrays 310, 316, 322 are provided on the print element substrate 300. Note that the number of heater arrays is not limited to three and may be two or more than three.

Note that the heater array 310 is accompanied by a nozzle array (not shown), an ink supply port 311, a driver array 309, an AND array 308, a shift register 306, and a decoder 307. Similarly, the heater array 316 is accompanied by a nozzle array (not shown), an ink supply port 317, a driver array 315, an AND array 314, a shift register 312, and a decoder 313. Also, the heater array 322 is accompanied by a nozzle array (not shown), an ink supply port 323, a driver array 321, an AND array 320, a shift register 318, and a decoder 319.

The set of the heater array 310 as well as its accompanying components, namely the nozzle array (not shown), the ink supply port 311, the driver array 309, the AND array 308, the shift register 306, and the decoder 307, is divided into two sets. The first set includes a heater array 310a as well as its accompanying components, namely a nozzle array (not shown), an ink supply port 311, a driver array 309a, an AND array 308a, a shift register 306a, and a decoder 307a. The second set includes a heater array 310b as well as its accompanying components, namely a nozzle array (not shown), an ink supply port 311, a driver array 309b, an AND array 308b, a shift register 306b, and a decoder 307b.

Similarly, the set of the heater array 316 as well as its accompanying components, namely the nozzle array (not shown), the ink supply port 317, the driver array 315, the AND array 314, the shift register 312, and the decoder 313, is divided into two sets. The first set includes a heater array 316a as well as its accompanying components, namely a nozzle array (not shown), an ink supply port 317, a driver array 315a, an AND array 314a, a shift register 312a, and a decoder 313a. The second set includes a heater array 316b as well as its accompanying components, namely a nozzle array (not shown), an ink supply port 317, a driver array 315b, an AND array 314b, a shift register 312b, and a decoder 313b.

Similarly, the set of the heater array 322 as well as its accompanying components, namely the nozzle array (not shown), the ink supply port 323, the driver array 321, the AND array 320, the shift register 318, and the decoder 319, is divided into two sets. The first set includes a heater array 322a as well as its accompanying components, namely a nozzle array (not shown), an ink supply port 323, a driver array 321a, an AND array 320a, a shift register 318a, and a decoder 319a. The second set includes a heater array 322b as well as its accompanying components, namely a nozzle array (not shown), an ink supply port 323, a driver array 321b, an AND array 320b, a shift register 318b, and a decoder 319b.

Reference numeral 302 is a halving line of the base 301 of the print element substrate 300 and does not actually exist on the base 301. This halving line 302 passes through the middle point of each nozzle array in terms of its extension direction. Also, this halving line 302 passes through the border point between the heater array 310a and the heater array 310b, the border point between the heater array 316a and the heater array 316b, and the border point between the heater array 322a and the heater array 322b. In a case where three heater arrays 310, 316, 322 like in the present embodiment are arranged in a zigzag manner, the halving line 302 is in a crank shape.

Note that the halving line 302 does not necessarily need to pass through the middle point of each heater array in terms of its extension direction (the X-direction) and may pass a point away from the middle point. Thus, the number of heaters included in the heater array 310a and the number of heaters included in the heater array 310b do not have to be equal. This applies to the other heater arrays as well.

Pads 303a to 303h and pads 304a to 304h for providing external electric connections are provided on the base 301. The pads 303a to 303h are provided on the left side of the halving line 302, and the pads 304a to 304h are provided on the right side of the halving line 302. The pads 303a to 303h constitute a first pad array 351, and the pads 304a to 304h constitute a second pad array 352. For both of the pad arrays, their extension directions coincide with the directions in which the heater arrays 310a, 310b extend. The first pad array 351 and the second pad array 352 together constitute a single pad array 353 for the print element substrate 300.

The pad array 353 including the first pad array 351 and the second pad array 352 is disposed on a lower marginal portion of the print element substrate 300 in FIGS. 3A and 3B. The direction in which this marginal portion extends coincides with the direction in which the heater arrays 310a, 310b and other heater arrays extend (the X-direction), but does not necessarily need to coincide with it precisely. The heater arrays 310a, 310b and other heater arrays are, specifically, the heater arrays 310a, 310b, 316a, 316b, 322a, and 322b.

Signal terminals for transferring image data from the outside to the print element substrate 300, power supply terminals for driving, and the like are assigned to the pads 303a to 303h and the pads 304a to 304h.

The print element substrate 300 is halved by the halving line 302 into a first functional block and a second functional block. The first functional block is a functional block located on the left side of the halving line 302, and the second functional block is a functional block located on the right side of the halving line 302.

The pads 303a to 303h correspond to the first functional block located on the left side of the halving line 302, and the pads 304a to 304h correspond to the second functional block located on the right side of the halving line 302. Signals supplied to the pads 303a to 303h from the main body of the printing apparatus are supplied to the circuits included in the first functional block on the print element substrate 300. Also, signals supplied to the pads 304a to 304h from the main body of the printing apparatus are supplied to the circuits included in the second functional block on the print element substrate 300.

The first functional block includes the heater array 310a as well as its accompanying components, namely the nozzle array (not shown), the ink supply port 311, the driver array 309a, the AND array 308a, the shift register 306a, and the decoder 307a. The first functional block further includes the heater array 316a as well as its accompanying components, namely the nozzle array (not shown), the ink supply port 317, the driver array 315a, the AND array 314a, the shift register 312a, and the decoder 313a. The first functional block further includes the heater array 322a as well as its accompanying components, namely the nozzle array (not shown), the ink supply port 323, the driver array 321a, the AND array 320a, the shift register 318a, and the decoder 319a.

Also, the second functional block includes the heater array 310b as well as its accompanying components, namely the nozzle array (not shown), the ink supply port 311, the driver array 309b, the AND array 308b, the shift register 306b, and the decoder 307b. The second functional block further includes the heater array 316b as well as its accompanying components, namely the nozzle array (not shown), the ink supply port 317b, the driver array 315b, the AND array 314b, the shift register 312b, and the decoder 313b. The second functional block further includes the heater array 322b as well as its accompanying components, namely the nozzle array (not shown), the ink supply port 323, the driver array 321b, the AND array 320b, the shift register 318b, and the decoder 319b.

An overview of the first functional block is described in terms of its operation. A serial signal representing image data is supplied from the outside to a DATA-A terminal 303d of the print element substrate 300. The serial signal is in synchronization with a CLK signal supplied to a CLK-A terminal 303c.

The serial signal and the CLK signal are supplied to the shift registers (S/R) 306a, 312a, and 318a via an input circuit 305a including an electrostatic discharge protection circuit and the like. In this event, the serial signal is inputted from an outer end portion of each of the shift registers 306a, 312a, and 318a and is shifted toward an inner end portion thereof. The outer end portion of each of the shift registers 306a, 312a, and 318a is an end portion farther from the halving line 302, and the inner end portion of each of the shift registers 306a, 312a, and 318a is an end portion closer to the halving line 302.

The shift register 306a, the decoder 307a, the AND array 308a, the driver array 309a, and the heater array 310a are configured and operate similarly to the corresponding components of the first embodiment, i.e., the shift register 206a, the decoder 207a, the AND array 208a, the driver array 209a, and the heater array 210a. Thus, repetitive descriptions are omitted.

Likewise, the shift register 312a, the decoder 313a, the AND array 314a, the driver array 315a, and the heater array 316a are configured and operate similarly to the corresponding components in the first embodiment, i.e., the shift register 206a, the decoder 207a, the AND array 208a, the driver array 209a, and the heater array 210a. Thus, repetitive descriptions are omitted.

Likewise, the shift register 318a, the decoder 319a, the AND array 320a, the driver array 321a, and the heater array 322a are configured and operate similarly to the corresponding components in the first embodiment, i.e., the shift register 206a, the decoder 207a, the AND array 208a, the driver array 209a, and the heater array 210a. Thus, repetitive descriptions are omitted.

The configuration and operation of the second functional block are the same as the configuration and operation of the first functional block; thus, repetitive descriptions are omitted.

While the direction in which the serial signal is shifted in the shift register 306a is from left to right in FIGS. 3A and 3B, the direction in which the serial signal is shifted in the shift register 306b is opposite to this. The shift register 312a and the shift register 312b too have the same relation. The shift register 318a and the shift register 318b too have the same relation. A head control IC (not shown) that supplies serial signals to the print element substrate 300 is supplied with the serial signals in the same one direction. Thus, the head control IC reverses the arrangement of data in either the serial signal supplied to the DATA-A terminal 303d or the serial signal supplied to a DATA-B terminal 304d before supplying the serial signals.

Note that ink is supplied to each pressure chamber through the ink supply ports 311, 317, and 323 formed in the base 301 of the print element substrate 300. The shape, quantity, position, and the like of the ink supply ports 311, 317, and 323 do not have to be as shown in the drawings.

### Third Embodiment

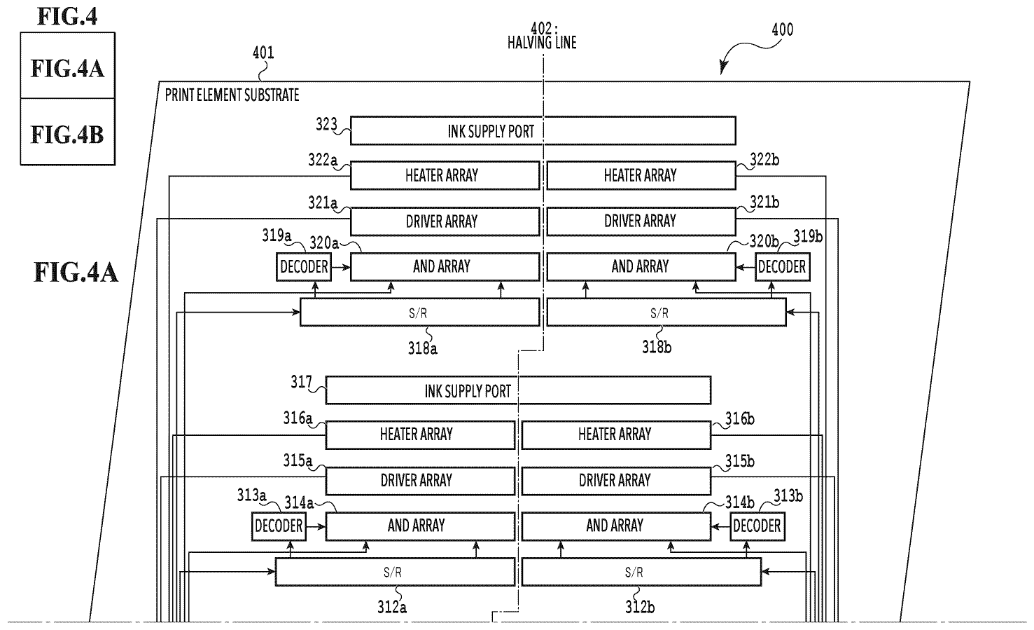

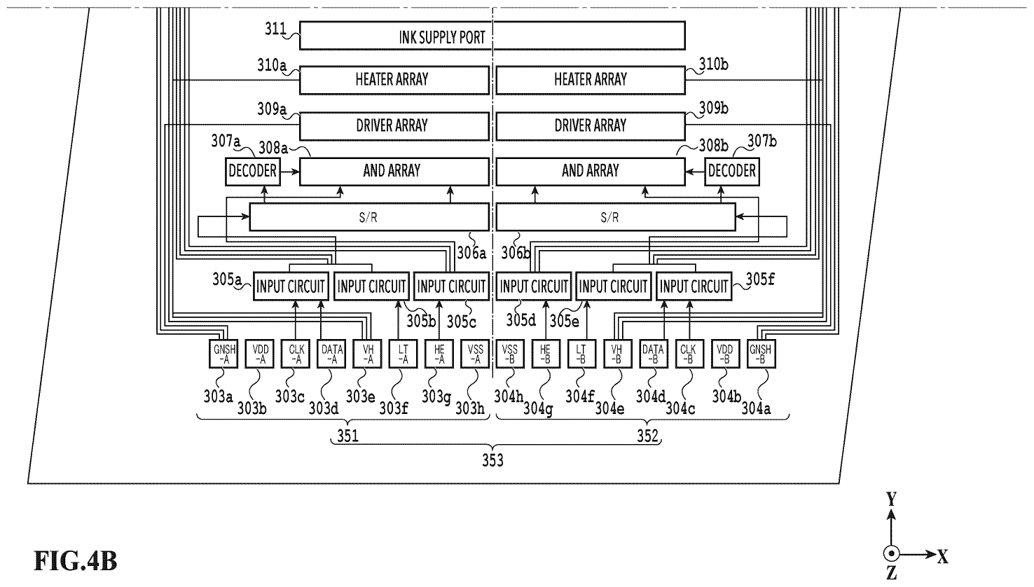

FIGS. 4A and 4B are schematic plan views showing a print element substrate according to a third embodiment.

A print element substrate 400 according to the present embodiment is a parallelogram in its planar shape. Also, the heater arrays 310, 316, and 322 included in the respective plurality of sets are disposed at positions offset from one another in stages in the heater array extension direction (the X-direction) as the positions move in a direction (the Y-direction) intersecting with the heater array extension direction. Further the parallelogram has an upper side and a lower side extending in the same direction as the heater array extension direction and two slanted sides extending along the positions where the plurality of heater arrays are disposed. The driver arrays, the AND arrays, and the shift registers (S/R) accompanying the respective heater arrays are similarly disposed at positions shifted from one another in stages in the heater array extension direction (the X-direction) as the positions move in a direction (the Y-direction) intersecting with the heater array extension direction. The other portions are the same as those in the second embodiment, and repetitive descriptions are omitted.

### Fourth Embodiment

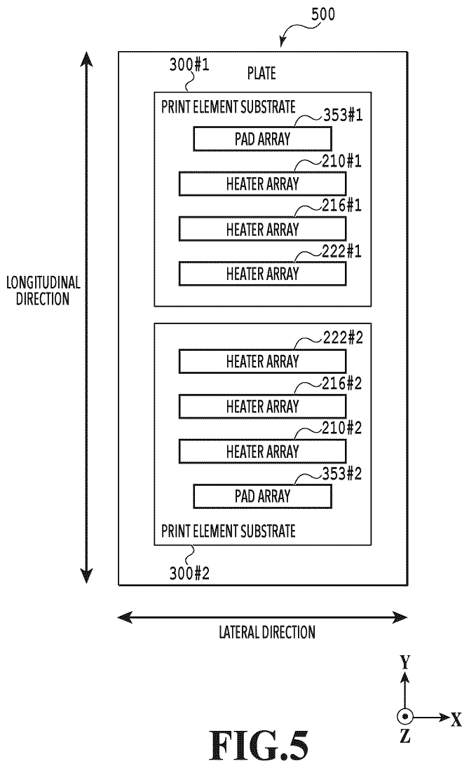

FIG. 5 is a schematic plan view showing an inkjet printing head according to a fourth embodiment. Two print element substrates 300#1 and 300#2 according to the second embodiment are disposed on a plate 500, arranged in a direction (the Y-direction) orthogonal to the direction in which heater arrays 210#1, 216#1, 222#1, 210#2, 216#2, and 222#2 extend (the X-direction). Also, the print element substrates 300#1 and 300#2 are disposed so that an area in the X-direction over which the heater arrays 210#1, 216#1, and 222#1 extend and an area in the X-direction over which the heater arrays 210#2, 216#2, and 222#2 extend may coincide with each other. In other words, the print element substrates 300#1 and 300#2 are disposed so that their positions may be the same in terms of the X-direction. Thus, the areas over which the six heater arrays 210#1, 216#1, 222#1, 210#2, 216#2, and 222#2 extend align in the extension direction (the X-direction).

Also, the orientation of the substrate 300#1 is adjusted so that a pad array 353#1 on the substrate 300#1 may be disposed at a marginal portion opposite from the side facing the substrate 300#2. This prevents a tape-automated bonding (TAB) tape (not shown) connected to the pad array 353#1 and extending upwards (+Y-direction) from the pad array 353#1 from interfering with the substrate 300#2.

Similarly, the orientation of the substrate 300#2 is adjusted so that a pad array 353#2 on the substrate 300#2 may be disposed at a marginal portion opposite from the side facing the substrate 300#1. This prevents a TAB tape (not shown) connected to the pad array 353#2 and extending downwards (−Y-direction) from the pad array 353#2 from interfering with the substrate 300#1.

Thus, the print element substrate 300#1 and the print element substrate 300#2 can be disposed on the plate 500 so as to be close to each other in a direction (the Y-direction) orthogonal to the heater array extension direction (the X-direction).

Note that in place of the print element substrate 300 according to the second embodiment, the print element substrate 200 according to the first embodiment or the print element substrate 400 according to the third embodiment may be disposed on the plate 500.

### Fifth Embodiment

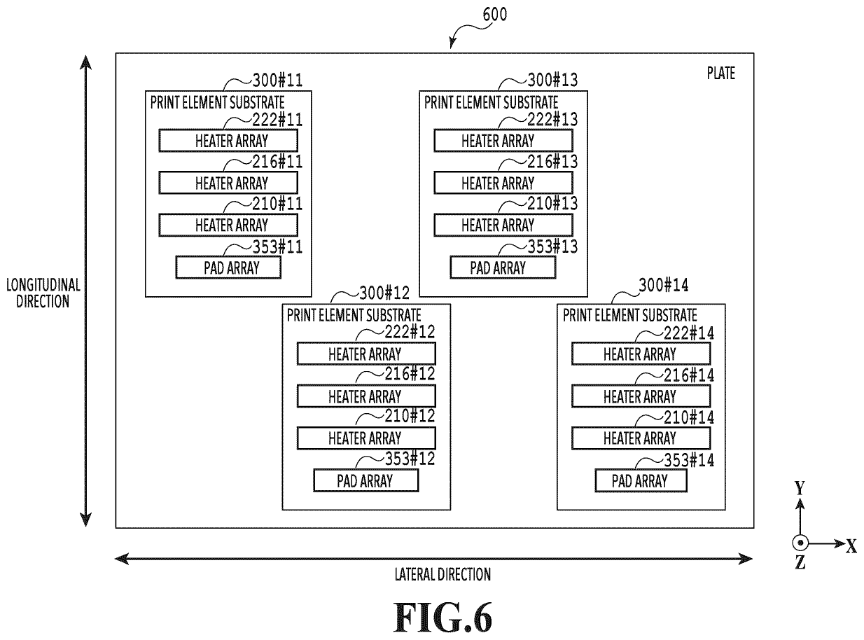

FIG. 6 is a schematic plan view showing an inkjet printing head according to a fifth embodiment. Four print element substrates 300#11, 300#12, 300#13, and 300#14 according to the second embodiment are disposed on a plate 600. The four print element substrates 300#11, 300#12, 300#13, and 300#14 are disposed in two rows extending in the heater array extension direction (the X-direction) in a zigzag manner. The heater arrays here are heater arrays 210#n, 216#n, and 222#n on the print element substrates 300#n (where n is 11 to 14). There are twelve heater arrays in total.

The print element substrate 300#11 and the print element substrate 300#12 are provided close to each other in a direction (the Y-direction) orthogonal to the heater array extension direction (the X-direction). Also, the print element substrate 300#11 and the print element substrate 300#12 are disposed so that one ends of the three heater arrays on the former and one ends of the three heaters on the latter coincide in position in the heater array extension direction. Specifically, the three heater arrays on the former are the heater arrays 210#11, 216#11, and 222#11, and the three heater arrays on the latter are the heater arrays 210#12, 216#12, and 222#12.

Similarly, the print element substrate 300#12 and the print element substrate 300#13 are disposed to satisfy a similar positional relation.

Similarly, the print element substrate 300#13 and the print element substrate 300#14 are disposed to satisfy a similar positional relation.

Thus, compared to a case where only one print element substrate 300 is disposed on the plate 600, the print width can be quadrupled in length. The nozzle arrays are disposed at the same positions as the corresponding heater arrays in terms of the XY-plane. Thus, compared to a case where only one print element substrate 300 is disposed on the plate 600, the virtual length of the nozzle arrays can be quadrupled.

Also, on the basis of the thus-formed nozzle array quadrupled in length, the heater array, the driver array, the AND array, and the shift register (S/R) can be divided into eight parts in the nozzle array extension direction. This makes it possible to maintain a high operating frequency.

Also, the pad array 353#n on the substrate 300#n (where n is 11 to 14) is disposed at a lower marginal portion of the substrate 300#n in FIG. 6, and there is no substrate disposed at a position facing this marginal portion. This prevents a TAB tape (not shown) connected to the pad array 353#n and extending downwards (−Y-direction) from the pad array 353#n from interfering with other substrates. Also, four TAB tapes can be commonly connected to a common single head control IC located beyond in the extension direction.

Note that in place of the print element substrate 300 according to the second embodiment, the print element substrate 200 according to the first embodiment or the print element substrate 400 according to the third embodiment may be disposed on the plate 600.

Also, the print element substrates 300#n (where n is 11 to 14) may be disposed in such a manner as to have an overlap portion near the end portions of the heater arrays on the print element substrates adjacent to each other.

Also, the number of print element substrates 300 on the plate and the pattern of the zigzag arrangement are not limited to what is described above. For example, three or more rows may be arranged in a zigzag manner.

### Sixth Embodiment

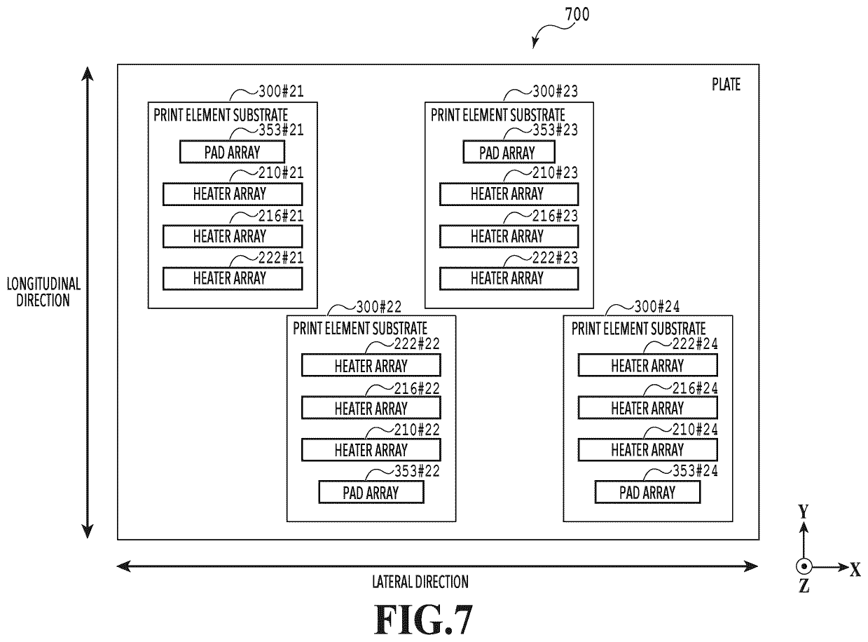

FIG. 7 is a schematic plan view showing an inkjet printing head according to a sixth embodiment. Four print element substrates 300#21, 300#22, 300#23, and 300#24 according to the second embodiment are disposed on a plate 700. The four print element substrates 300#21, 300#22, 300#23, and 300#24 are disposed in two rows extending in the heater array extension direction (the X-direction) in a zigzag manner. The heater arrays here are heater arrays 210#n, 216#n, and 222#n on the print element substrates 300#n (where n is 21 to 24). There are twelve heater arrays in total.

The print element substrate 300#21 and the print element substrate 300#22 are provided close to each other in a direction (the Y-direction) orthogonal to the heater array extension direction (the X-direction). Also, the print element substrate 300#21 and the print element substrate 300#22 are disposed so that one ends of the three heater arrays on the former and one ends of the three heaters on the latter coincide in position in the heater array extension direction. Specifically, the three heater arrays on the former are heater arrays 210#21, 216#21, and 222#21, and the three heater arrays on the latter are heater arrays 210#22, 216#22, and 222#22.

Similarly, the print element substrate 300#22 and the print element substrate 300#23 are disposed to satisfy a similar positional relation.

Similarly, the print element substrate 300#23 and the print element substrate 300#24 are disposed to satisfy a similar positional relation.

Thus, compared to a case where only one print element substrate 300 is disposed on the plate 700, the print width can be quadrupled in length. The nozzle arrays are disposed at the same positions as the corresponding heater arrays in terms of the XY-plane. Thus, compared to a case where only one print element substrate 300 is disposed on the plate 700, the virtual length of the nozzle array can be quadrupled.

Also, on the basis of the thus-formed nozzle array quadrupled in length, the heater array, the driver array, the AND array, and the shift register (S/R) can be divided into eight parts in the nozzle array extension direction. This makes it possible to maintain a high operating frequency.

The present embodiment differs from the fifth embodiment in that on every print element substrates 300#n (where n is 21 to 24), the pad array 353#n is located at a marginal portion on a side opposite from the side facing the print element substrate which is close to the print element substrates 300#n. The configuration of the present embodiment can be achieved by rotating the print element substrate 300#11 and 300#13 of the fifth embodiment 180° on the XY-plane.

The pad array 353#n on the substrate 300#n (where n is 21, 23) is disposed on an upper marginal portion of the substrate 300#n in FIG. 7, and there is no other substrate disposed at a position facing this marginal portion. This prevents a TAB tape (not shown) connected to the pad array 353#n and extending upwards (+Y-direction) from the pad array 353#n from interfering with other substrates. Also, two TAB tapes can be commonly connected to a common single head control IC located beyond in the extension direction.

Similarly, the pad array 353#n on the substrate 300#n (where n is 22, 24) is disposed on a lower marginal portion of the substrate 300#n in FIG. 7, and there is no other substrate disposed at a position facing this marginal portion. This prevents a TAB tape (not shown) connected to the pad array 353#n and extending downwards (−Y-direction) from the pad array 353#n from interfering with other substrates. Also, two TAB tapes can be commonly connected to a common single head control IC located beyond in the extension direction.

Note that in place of the print element substrate 300 according to the second embodiment, the print element substrate 200 according to the first embodiment or the print element substrate 400 according to the third embodiment may be disposed on the plate 700.

Also, the print element substrates 300#n (where n is 21 to 24) may be disposed to have an overlap portion near the end portions of the heater arrays on the print element substrates adjacent to each other.

Also, the number of print element substrates 300 on the plate and the pattern of the zigzag arrangement are not limited to what is described above. For example, three or more rows may be arranged in a zigzag manner.

### Seventh Embodiment

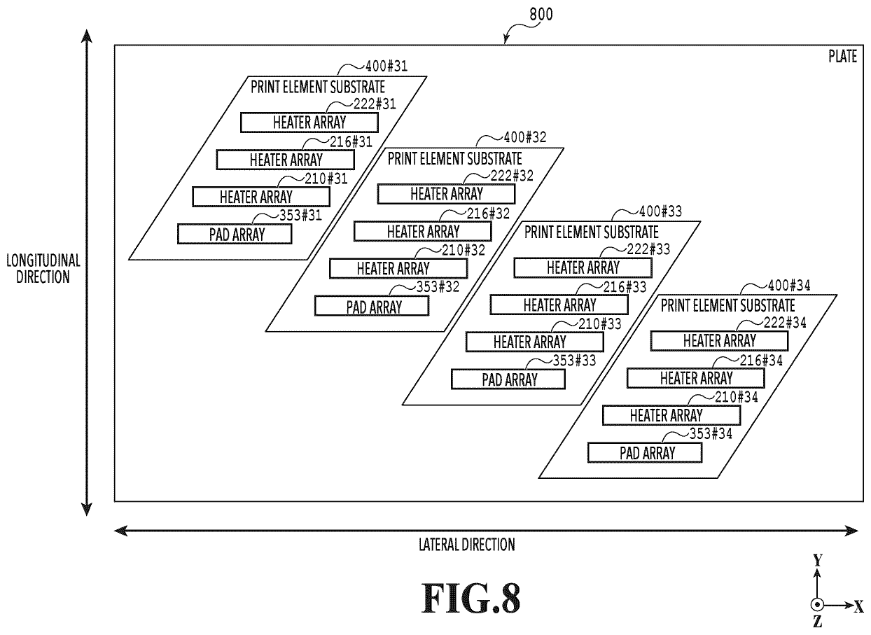

FIG. 8 is a schematic plan view showing an inkjet printing head according to a seventh embodiment. Four print element substrates 400#31, 400#32, 400#33, and 400#34 according to the third embodiment are disposed on a plate 800. The four print element substrates 400#31, 400#32, 400#33, and 400#34 are disposed as follows. Specifically, each pair of the print element substrates 400#n and 400#(n+1) (where n=31 to 33) adjacent to each other are disposed so that their sides at an angle not perpendicular to the heater array extension direction (the X-direction) in planar directions (the XY-directions) (i.e., slanted sides) may be adjacent to each other. Also, the print element substrates 400#n (n=31 to 34) are disposed so that their corners with acute angles protrude. In the example in FIG. 8, the print element substrates 400#n are each arranged so that its upper right corners and lower left corners protrude. Also, as is apparent from FIG. 8, from another perspective, a pair of print element substrates 400#n and 400#(n+1) adjacent to each other are arranged in such a manner as to partially overlap in the heater array extension direction (the X-direction) and also to partially overlap in a direction (the Y-direction) intersecting with the heater array extension direction. Despite that, a pair of print element substrates 400#n and 400#(n+1) adjacent to each other do not overlap on the XY plane because the print element substrates 400 are each a parallelogram in planar shape.

Then, focusing on a pair of print element substrates 400#n and 400#(n+1) (where n=31 to 33) adjacent to each other, the following configuration can be obtained. Specifically, an end portion of the heater array 210#n of the print element substrate 400#n and an end portion of the heater array 210#(n+1) of the print element substrate 400#(n+1) can coincide or overlap in the heater array extension direction. Similarly, an end portion of the heater array 216#n of the print element substrate 400#n and an end portion of the heater array 216#(n+1) of the print element substrate 400#(n+1) can coincide or overlap in the heater array extension direction. Also, an end portion of the heater array 222#n of the print element substrate 400#n and an end portion of the heater array 222#(n+1) of the print element substrate 400#(n+1) can coincide or overlap in the heater array extension direction.

Thus, compared to a case where only one print element substrate 400 is disposed on the plate 800, the print width can be quadrupled in length. The nozzle arrays are disposed at the same positions as the corresponding heater arrays in terms of the XY-plane. Thus, compared to a case where only one print element substrate 400 is disposed on the plate 800, the virtual length of the nozzle array can be quadrupled.

Also, on the basis of the thus-formed nozzle array quadrupled in length, the heater array, the driver array, the AND array, and the shift register (S/R) can be divided into eight parts in the nozzle array extension direction. This makes it possible to maintain a high operating frequency.

Further, the length of an area occupied by the print element substrates 400#n (n=31 to 34) in a direction (the Y-direction) orthogonal to the heater array extension direction (the X-direction) is less than double the length of an area occupied by a single print element substrate 400. In the example in FIG. 8, it is approximately 1.5 times. By contrast, in the fifth and sixth embodiments, it is double. Thus, the Y-direction size of the plate 800 according to the present embodiment can be made smaller than those of the plates 600, 700 according to the fifth and sixth embodiments. Thus, according to the seventh embodiment, the inkjet printing head can be reduced in size compared to those of the fifth and sixth embodiments.

Also, the pad array 353#n on the substrate 400#n (where n is 31 to 34) is disposed at a lower marginal portion of the substrate 400#n in FIG. 8, and there is no other substrate disposed at a position facing this marginal portion. This prevents a TAB tape (not shown) connected to the pad array 353#n and extending downwards (−Y-direction) from the pad array 353#n from interfering with other substrates. Also, four TAB tapes can be commonly connected to a common single head control IC located beyond in the extension direction.

Note that the number of print element substrates 400 on the plate and the pattern of the arrangement are not limited to what is described above.

### Eighth Embodiment

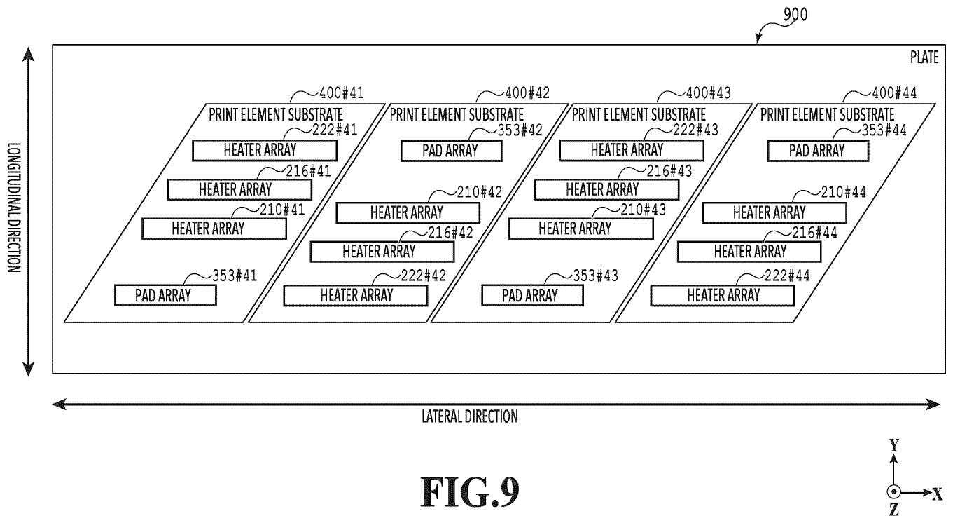

FIG. 9 is a schematic plan view showing an inkjet printing head according to an eighth embodiment. Four print element substrates 400#41, 400#42, 400#43, and 400#44 according to the third embodiment are disposed on a plate 900. The four print element substrates 400#41, 400#42, 400#43, and 400#44 are disposed as follows. Specifically, each pair of the print element substrates 400#n and 400#(n+1) (where n=41 to 43) adjacent to each other are disposed so that their sides at an angle not perpendicular to the heater array extension direction (the X-direction) in planar directions (the XY-directions) (i.e., slanted sides) may be adjacent to each other. Also, the print element substrates 400#n (n=41 to 44) are disposed so that their positions may be the same in a direction (the Y-direction) perpendicular to the heater array extension direction (the X-direction). Further, the pad arrays 353#n are disposed at a marginal portion on the −Y-direction side and a marginal portion on the −Y-direction side of the print element substrates alternately. Each pair of print element substrates 400 adjacent to each other have a relation such that one of them is rotated 180° relative to the other on the XY-plane.

Then, focusing on a pair of print element substrates 400#n and 400#(n+1) (n=41, 43) adjacent to each other, the following configuration can be obtained. Thus, an end portion of the heater array 210#n of the print element substrate 400#n and an end portion of the heater array 210#(n+1) of the print element substrate 400#(n+1) can coincide or overlap in the heater array extension direction. Similarly, an end portion of the heater array 216#n of the print element substrate 400#n and an end portion of the heater array 216#(n+1) of the print element substrate 400#(n+1) can coincide or overlap in the heater array extension direction. Also, an end portion of the heater array 222#n of the print element substrate 400#n and an end portion of the heater array 222#(n+1) of the print element substrate 400#(n+1) can coincide or overlap in the heater array extension direction.

Note that with regards to the pair of print element substrates 400#42 and 400#43 adjacent to each other, their end portions cannot coincide or overlap.

Thus, ignoring the discontinuity between the print element substrate 400#42 and the print element substrate 400#43, the print width can be quadrupled in length compared to a case where a single print element substrate 400 is disposed on the plate 900. Also, without ignoring the discontinuity between the print element substrate 400#42 and the print element substrate 400#43, the print width can be doubled in length compared to a case where a single print element substrate 400 is disposed on the plate 900.

The nozzle arrays are disposed at the same positions as the corresponding heater arrays on the XY-plane. Thus, two nozzle arrays virtually doubled in length can be provided compared to a case where only a single print element substrate 400 is disposed on the plate 900.

Also, on the basis of each one of the thus-formed nozzle arrays doubled in length, the heater array, the driver array, the AND array, and the shift register (S/R) can be divided into four parts in the nozzle array extension direction. This makes it possible to maintain a high operating frequency.

Further, the length of an area occupied by the print element substrates 400#n (n=41 to 44) in a direction (the Y-direction) orthogonal to the heater array extension direction (the X-direction) is the same as the length of an area occupied by a single print element substrate 400. By contrast, it is double in the fifth and sixth embodiments and is approximately 1.5 times in the seventh embodiment. Thus, the Y-direction size of the plate 900 according to the present embodiment can be made smaller than those of the plates 600, 700, 800 according to the fifth to seventh embodiments. Thus, according to the eighth embodiment, the inkjet printing head can be reduced in size compared to those of the fifth to seventh embodiments.

Also, the pad array 353#n on the substrate 400#n (where n is 41 to 44) is disposed at a lower marginal portion of the substrate 400#n in FIG. 9, and there is no other substrate disposed at a position facing this marginal portion. This prevents a TAB tape (not shown) connected to the pad array 353#n and extending downwards (−Y-direction) from the pad array 353#n from interfering with other substrates. Also, four TAB tapes can be commonly connected to a common single head control IC located beyond in the extension direction.

Note that the number of print element substrates 400 on the plate is not limited to the above.

### Other Embodiments

In the arrangement shown in FIG. 8, the print element substrates may be disposed such that they are rotated 180° alternately as shown in FIG. 9.

In the arrangement shown in FIG. 9, the print element substrate 400#43 and the print element substrate 400#44 may be moved to a lower left direction to make the heater arrays on the print element substrate 400#42 and the heater arrays on the print element substrate 400#43 continuous with each other in the heater array extension direction. The heater arrays that are made continuous here are the heater array 210#42 and the heater array 210#43. The heater arrays that are made continuous here are also the heater array 216#42 and the heater array 216#43. The heater arrays that are made continuous here are also the heater array 222#42 and the heater array 222#43.

The print element substrate 300 does not necessarily have to be rectangular in planar shape. Thus, the print element substrate 300 may have other planar shapes as long as the heater arrays and the pad arrays can be configured on the plate with the positional relations as shown in FIGS. 5 to 7.

The print element substrate 400 does not necessarily have to be a parallelogram in planar shape. Thus, the print element substrate 400 may have other planar shapes as long as the heater arrays and the pad arrays can be configured on the plate with the positional relations as shown in FIGS. 8 and 9. For example, the print element substrates 400 may have irregular marginal portions so that the print element substrates may be disposed on the plate with their heater arrays and pad arrays satisfying the positional relations as shown in FIG. 8. Then, the print element substrates 400 may be disposed on the plate like jigsaw puzzle pieces, with protruding portions and indented portions interlocking together between the print element substrates adjacent to each other. Also, the print element substrates may basically be parallelograms, with protruding or indented portions for positioning added thereto. Also, the print element substrates may be modified such that the corners of each print element substrate 400 with acute angles are round.

A heater array used in the above embodiments is formed by a plurality of heaters arranged in the extension direction as an energy generation element array formed by a plurality of energy generation elements arranged in the extension direction. However, the present disclosure is not limited to this, and a piezoelectric element array formed by a plurality of piezoelectric elements arranged in the extension direction may be used as an energy generation element array.

As the energy generation element array, a plurality of energy generation elements may be arranged in one row or in a plurality of rows (e.g., two rows) along the extension direction. Further, as the energy generation element array, for example, the plurality of energy generation elements may be arranged in two rows extending in a zigzag manner in the extension direction.

In the above embodiments, the pad array extension direction is the same as the heater array extension direction. However, the present disclosure is not limited to this, and the pad array extension direction may be slanted relative to the heater array extension direction. Specifically, the pad array extension direction only has to have a component in the same direction as the heater array extension direction and may have a component in a direction perpendicular to the heater array extension direction on the plane of the print element substrate. For example, regarding the pad array on the print element substrate 400 shown in FIGS. 4A and 4B, the extension direction of a TAB tape connected to the pad array may have such an angle as to be parallel to the slanted sides of the print element substrate 400.

The above embodiments have described a configuration of the print element substrate where a serial signal is inputted from an outer end portion of the shift register and shifted toward an inner end portion thereof. However, the present disclosure is not limited to this, and the print element substrate may be configured so that in one or both of the two shift registers, a serial signal is inputted from an inner end portion of the shift register and shifted toward an outer end portion thereof. Note that the order of data in a serial signal inputted from the outside may be adjusted according to the configuration.

Although the above embodiments describe an inkjet printing head that ejects ink, the inkjet printing head may eject liquid other than ink.

The present disclosure can increase the virtual length of the nozzle array while maintaining a high operating frequency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A print element substrate comprising:
an energy generation element array including a plurality of energy generation elements each configured to apply energy to liquid in a corresponding pressure chamber;
a pad array including a plurality of pads used for inputting, from outside, a plurality of signals for driving the plurality of energy generation elements;
a drive element array including a plurality of drive elements each configured to drive a corresponding one of the energy generation elements;
a logical circuit array including a plurality of logical circuits each configured to enable a corresponding one of the drive elements based at least on data inputted from a shift register; and
the shift register configured to, based on a clock signal inputted from outside, shift a serial signal inputted from outside and used for driving the plurality of energy generation elements and then hold the serial signal, wherein an extension direction of the pad array has a component in a same direction as an extension direction of the energy generation element array, the plurality of pads include at least a pad for inputting the serial signal from outside and a pad for inputting the clock signal from outside, an extension direction of the drive element array, an extension direction of the logical circuit array, and an extension direction of the shift register have a component in a same direction as the extension direction of the energy generation element array, and the pad array is disposed at a position different from the energy generation element array, the drive element array, the logical circuit array, and the shift register in a direction intersecting with the extension direction of the energy generation element array.

2. The print element substrate according to claim 1, wherein the extension direction of the pad array is same as the extension direction of the energy generation element array.

3. The print element substrate according to claim 1, wherein the pad array is provided at a marginal portion of the print element substrate, the marginal portion extending in the extension direction of the energy generation element array.

4. The print element substrate according to claim 1, wherein the extension direction of the drive element array, the extension direction of the logical circuit array, and the extension direction of the shift register are same as the extension direction of the energy generation element array.

5. The print element substrate according to claim 1, wherein a set including the energy generation element array, the drive element array, the logical circuit array, the shift register, and the pad array is divided into a first set and a second set, the first set including the energy generation element array, the drive element array, the logical circuit array, the shift register, and the pad array which are disposed closer to a first end portion of the print element substrate in terms of the extension direction of the energy generation element array, the second set including the energy generation element array, the drive element array, the logical circuit array, the shift register, and the pad array which are disposed closer to a second end portion of the print element substrate in terms of the extension direction of the energy generation element array.

6. The print element substrate according to claim 5, wherein the energy generation element array, the drive element array, and the logical circuit array belonging to the first set operate based on data outputted from the shift register belonging to the first set, and the energy generation element array, the drive element array, and the logical circuit array belonging to the second set operate based on data outputted from the shift register belonging to the second set.

7. The print element substrate according to claim 5, wherein the shift register included in the first set receives input of a first serial signal from a first end portion of the shift register belonging to the first set in terms of the extension direction of the shift register and shifts the first serial signal toward a second end portion of the shift register belonging to the first set in terms of the extension direction of the shift register. 8 The print element substrate according to claim 5, wherein the shift register included in the second set receives input of a second serial signal from a third end portion of the shift register belonging to the second set in terms of the extension direction of the shift register and shifts the second serial signal toward a fourth end portion of the shift register belonging to the second set in terms of the extension direction of the shift register.

9. The print element substrate according to claim 1, comprising a plurality of sets of the energy generation element array, the drive element array, the logical circuit array, and the shift register, the plurality of sets being arrayed in the direction intersecting with the extension direction of the energy generation element array.

10. The print element substrate according to claim 9, wherein the energy generation element arrays included in the respective plurality of sets are disposed at a common position in terms of the extension direction of the energy generation element array.

11. The print element substrate according to claim 9, wherein the energy generation element arrays included in the respective plurality of sets are disposed at positions offset from one another in stages in the extension direction of the energy generation element array as the positions move in the direction intersecting with the extension direction of the energy generation element array.

12. An inkjet printing head including a plate and a print element substrate provided on the plate, the print element substrate comprising:
an energy generation element array including a plurality of energy generation elements each configured to apply energy to liquid in a corresponding pressure chamber;
a pad array including a plurality of pads for inputting, from outside, a plurality of signals for driving the plurality of energy generation elements;
a drive element array including a plurality of drive elements each configured to drive a corresponding one of the energy generation elements;
a logical circuit array including a plurality of logical circuits each configured to enable a corresponding one of the drive elements based at least on data inputted from a shift register; and
the shift register configured to, based on a clock signal inputted from outside, shift a serial signal inputted from outside and used for driving the plurality of energy generation elements and then hold the serial signal, wherein an extension direction of the pad array has a component in a same direction as an extension direction of the energy generation element array, the plurality of pads include at least a pad for inputting the serial signal from outside and a pad for inputting the clock signal from outside, an extension direction of the drive element array, an extension direction of the logical circuit array, and an extension direction of the shift register have a component in a same direction as the extension direction of the energy generation element array, and the pad array is disposed at a position different from the energy generation element array, the drive element array, the logical circuit array, and the shift register in a direction intersecting with the extension direction of the energy generation element array.

13. The inkjet printing head according to claim 12, wherein a plurality of the print element substrates are arranged in the direction intersecting with the extension direction of the energy generation element array.

14. The inkjet printing head according to claim 12, wherein the pad array is provided at a marginal portion of the print element substrate, the marginal portion extending in the extension direction of the energy generation element array, a plurality of the print element substrates are disposed in two rows in a zigzag manner in the direction intersecting with the extension direction, and the marginal portion of each of the print element substrates where the pad array is disposed is at a common side among the plurality of print element substrates.

15. The inkjet printing head according to claim 12, wherein the pad array is provided at a marginal portion of the print element substrate, the marginal portion extending in the extension direction of the energy generation element array, a plurality of the print element substrates are disposed in two rows in a zigzag manner in the direction intersecting with the extension direction, and on each of the plurality of print element substrates belonging to a first one of the rows, the marginal portion where the pad array is disposed is at an opposite side from a side close to a second one of the rows, and on each of the plurality of print element substrates belonging to the second one of the rows, the marginal portion where the pad array is disposed in is at an opposite side from a side close to the first one of the rows.

16. The inkjet printing head according to claim 12, comprising a plurality of sets of the energy generation element array, the drive element array, the logical circuit array, and the shift register, the plurality of sets being arrayed in the direction intersecting with the extension direction of the energy generation element array, wherein the energy generation element arrays included in the respective plurality of sets are disposed at a common position in terms of the extension direction of the energy generation element array, a plurality of the print element substrates are arranged in a zigzag manner, and at least one pair of the print element substrates adjacent to each other are arranged such that the energy generation element arrays included in the respective plurality of sets on a first one of the print element substrates and the energy generation element arrays included in the respective plurality of sets on a second one of the print element substrates are continuous with each other or have an overlap portion in the extension direction of the energy generation element array.

17. The inkjet printing head according to claim 12, comprising a plurality of sets of the energy generation element array, the drive element array, the logical circuit array, and the shift register, the plurality of sets being arrayed in the direction intersecting with the extension direction of the energy generation element array, wherein the energy generation element arrays included in the plurality of sets are disposed at positions offset from one another in stages in the extension direction of the energy generation element array as the positions move in the direction intersecting with the extension direction of the energy generation element array, a plurality of the print element substrates are arranged in such a manner as to be continuous in the extension direction of the energy generation element array, at least one pair of the print element substrates adjacent to each other are arranged such that the energy generation element arrays included in the respective plurality of sets on a first one of the print element substrates and the energy generation element arrays included in the respective plurality of sets on a second one of the print element substrates are continuous with each other or have an overlap portion in the extension direction of the energy generation element array.

18. The inkjet printing head according to claim 17, wherein at least one pair of the print element substrates adjacent to each other are arranged such that areas over which the print element substrates extend overlap partially in the extension direction of the energy generation element array and also overlap partially in the direction intersecting with the extension direction of the energy generation element array.

19. The inkjet printing head according to claim 17, wherein on each of the print element substrates, the pad array is provided at a marginal portion of the print element substrate, the marginal portion extending in the extension direction of the energy generation element array, and the marginal portion of each of the print element substrates where the pad array is disposed is at a common side among the plurality of print element substrates. 20 The inkjet printing head according to claim 17, wherein the plurality of print element substrates are disposed in such a manner as to be located at a same position in terms of the direction intersecting with the extension direction of the energy generation element array.
